(19) United States
(12) Patent Application Publication
(10) Pub. No.: US 2002/0125826 A1
(43) Pub. Date: Sep. 12, 2002

(54) Microwave oven and method for controlling voltage thereof

(76) Inventors: Chul Kim, Anyang city (KR); Sung-ho Lee, Suwon city (KR); Young-won Cho, Suwon city (KR); Tae-soo Kim, Seoul city (KR)

Correspondence Address: Robert E. Bushnell, Suite 300, 1522 K Street, N.W., Washington, DC, 20005, US

(21) Appl. No.: 09/920,621

(22) Filed: Aug. 3, 2001

(30) Foreign Application Priority Data
Mar. 9, 2001 (KR) 12339/2001

(51) Int. Cl. H01J 25/50

(52) U.S. Cl. 315/39.51

(57) ABSTRACT

Disclosed is a microwave oven comprising a magnetron having an anode, a cathode and a filament, and a high voltage transformer having a primary coil and a secondary coil for supplying a high voltage to the magnetron. The microwave oven comprises a capacitor connected in parallel to the secondary coil of the high voltage transformer, forming a resonance circuit with the secondary coil. With this configuration, the performance of the magnetron is maintained by lowering the anode peak voltage applied thereto during the early non-oscillating period, and the circuit elements are protected from damage by removing the surge voltage.

### CLAIM OF PRIORITY

This application makes reference to, incorporates the same herein, and claims all benefits accruing under 35 U.S.C. §119 from an application for MICROWAVE OVEN AND VOLTAGE CONTROLLING METHOD THEREOF earlier filed in the Korean Industrial Property Office on Mar. 9, 2001 and there duly assigned Serial No. 2001-12339.

### BACKGROUND OF THE INVENTION

1. Field of the Invention

The present invention relates in general to a microwave oven and a method for controlling voltage thereof, and more particularly, a microwave oven and a method for controlling voltage thereof, which can lower an anode peak voltage applied to a magnetron during an early non-oscillating period, and remove a surge voltage.

1. Description of the Relate Art

Generally, a microwave oven is, as shown in FIG. 4, comprised of a high voltage transformer 55 generating high voltage from external AC (alternating current) power, and a magnetron 51 generating electromagnetic waves.

The secondary part of the high voltage transformer 55 comprises two coils connected in parallel, and having different lengths each other. Where AC power is supplied to the primary coil of the high voltage transformer 55, different voltages are respectively induced in the two coils of the secondary part thereof. In one of the two coils is induced a voltage of several volts for heating a filament of the magnetron 51, and in the other one is induced an AC pulse voltage of several thousands volts for being supplied to a cathode and an anode of the magnetron 51.

If the voltages induced from the high voltage transformer 55 heats the filament of the magnetron 51 and are supplied to the cathode and the anode of the magnetron 51, the magnetron 51 oscillates, to thereby generate electromagnetic waves.

In order to respectively supply DC (direct current) power to the cathode and the anode of the magnetron 51, in the secondary part of the high voltage transformer 55 is installed a rectifying circuit. The rectifying circuit includes a rectifying diode 61 and a smoothing capacitor 62 which are connected each other in parallel. The rectifying diode 61 rectifies the AC pulse voltage from the high voltage transformer 55, and the smoothing capacitor 62 smoothes the AC pulse voltage rectified by the rectifying diode 61.

In this conventional microwave oven, as illustrated in FIG. 5, there are problems that a circuit element susceptible to voltage is damaged by a surge voltage generated at the beginning of a magnetron operation or during the magnetron operation, etc.

Moreover, even if high voltage is respectively supplied to the cathode and the anode, the magnetron 51 does not oscillate until the filament is heated. However, when the magnetron 51 starts to operate, about 8,000 volts of anode peak voltage is supplied to the anode and the cathode until the filament is heated, namely, during a non-oscillating period. Because of the excessive high voltage supplied to the anode and the cathode during the early non-oscillating period, the performance of the magnetron 51 is lowered and the noise of the filament is instantaneously amplified. Further, because an excessive high voltage is supplied to the rectifying diode 61 in an inverse direction, the rectifying diode 61 can be damaged.

In order to solve these problems, in a conventional method, on the power input part of the high voltage transformer 55 are installed a relay and a resistance which are connected each other in parallel. At the beginning of supplying electric power, external AC power is supplied to the high voltage transformer 55 through the resistance by turning off the relay for a predetermined time. Then, the resistance can remove the surge voltage.

However, the manufacturing cost is raised because of the relay and the resistance. Also, if the relay is repeatedly turned on and off to operate the microwave oven, the contact of the relay may be defective and the resistance may be damaged. Further, the capacity of the rectifying diode 61 may be increased in order to prevent the rectifying diode 61 from being damaged, but there is the limit to the increase of the capacity.

### SUMMARY OF THE INVENTION

Accordingly, the present invention has been made keeping in mind the above-described shortcoming and user's need, and an object of the present invention is to provide a microwave oven and a method for controlling voltage thereof, which can lower an anode peak voltage applied to a magnetron during an early non-oscillating period, and remove a surge voltage.

This and other objects of the present invention may be accomplished by the provision of a microwave oven comprising a magnetron having an anode, a cathode and a filament, and a high voltage transformer having a primary coil and a secondary coil for supplying a high voltage to the magnetron, further comprising a capacitor connected in parallel to the secondary coil of the high voltage transformer, forming a resonance circuit with the secondary coil.

Preferably, the secondary coil is comprised of a first coil part connected to the filament of the magnetron and the second coil part connected to the cathode and the anode of the magnetron; and the capacitor is connected in parallel to the second coil part.

Desirably, the secondary coil of the high voltage transformer is provided a rectifying circuit including a smoothing capacitor and a rectifying diode, and the smoothing capacitor is installed between the high voltage transformer and the rectifying circuit.

According to another aspect of the present invention, the above and other objects may be also achieved by the provision of a method for controlling voltage in a microwave oven comprising a magnetron and a high voltage transformer; including the steps of converting voltage supplied from the outside into a high voltage through the high voltage transformer; resonating the high voltage; and supplying the high voltage to the magnetron.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a circuit diagram of a microwave oven according to the present invention;

FIG. 2 is a graph of a voltage waveform supplied to a filament according to the circuit of FIG. 1;

FIG. 3 is a graph of a voltage waveform supplied to a cathode according to the circuit of FIG. 1;

FIG. 4 is a circuit diagram of a conventional microwave oven; and

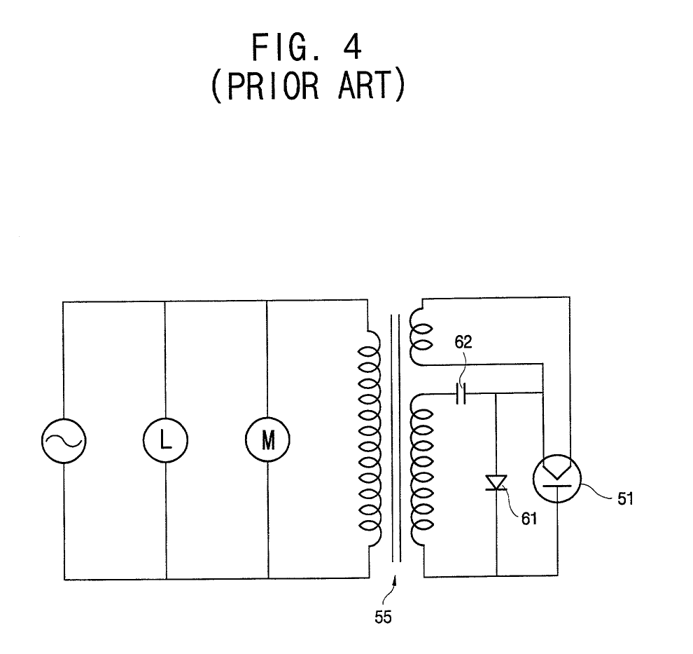

FIG. 5 is a graph of a voltage waveform supplied to a filament according to the circuit of FIG. 4.

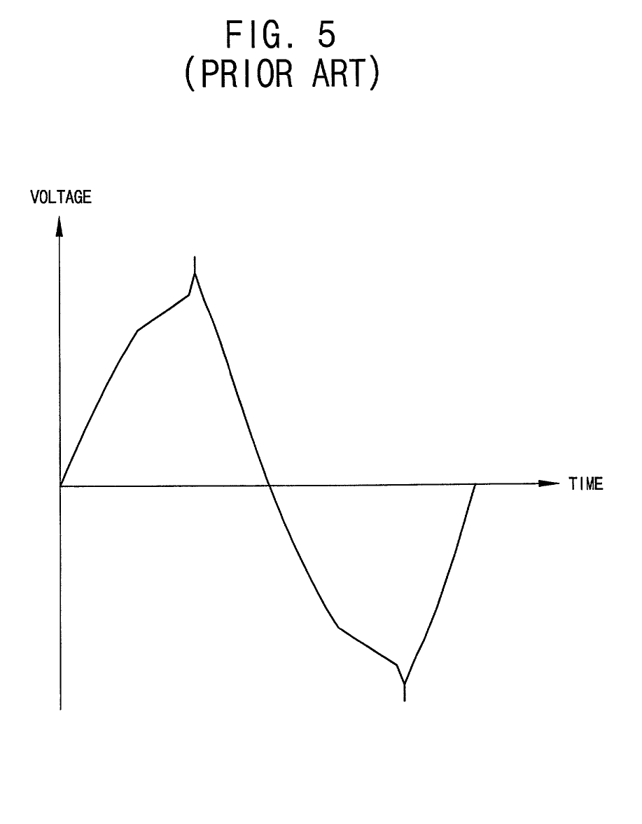

### DETAILED DESCRIPTION OF THE PREFERRED EMBODIMENT

A preferred embodiment of the present invention will be described in more detail with reference to the accompanying drawings.

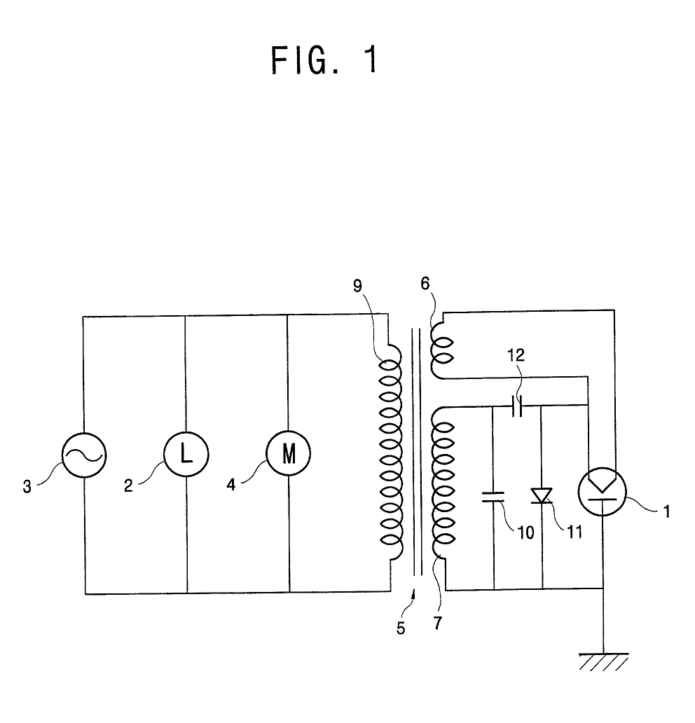

Referring to FIG. 1, a microwave oven according to the present invention is comprised of a power supply part 3, a high voltage transformer 5 generating a high voltage, and a magnetron 1 generating electromagnetic waves by the high voltage generated by the high voltage transformer 5.

Between the power supply part 3 and a primary coil 9 of the high voltage transformer 5 are provided a lamp 2 lighting up a cooking chamber (not shown), and a cooling fan motor 4 cooling the components including the high voltage transformer 5, the magnetron 1, etc. The lamp 2 and the cooling fan motor 4 are mutually connected in parallel.

A secondary coil of the high voltage transformer 5 is divided into two parts, first and second coil parts 6 and 7, which have different lengths each other. In the first coil part 6 is induced a voltage of several volts, and in the second coil part 7 is induced a voltage of several thousands volts.

The magnetron 1 comprises an anode forming a cavity for resonance, a cathode being in the middle of the cavity for resonance, and a filament heating the cathode to emit electrons. The filament is connected to the first coil part 6 of the high voltage transformer 5, and the voltage of several volts is supplied thereto. The anode and the cathode are respectively connected to opposite ends of the second coil part 7, and the voltage of several thousands volts is supplied therebetween. This several thousands volts voltage is called an anode peak voltage.

The magnetron 1 generates electromagnetic waves by emitting electrons from the cathode, by heating the filament by the voltage supplied from the first coil part 6 of the high voltage transformer 5. The period from the time when the high voltage from the high voltage transformer 5 is supplied to the anode and the cathode to the time when the filament is heated, is called an early non-oscillating period. The voltage between the anode and the cathode of the magnetron 1 during this period is called a non-oscillating anode peak voltage.

To the second coil part 7 of the secondary coil of the high voltage transformer 5 is installed a rectifying circuit converting an AC high voltage supplied to the magnetron 1 into a DC high voltage. The rectifying circuit includes a smoothing capacitor 12 connected to one side of the second coil part 7, rectifying the AC high voltage, and a rectifying diode 11 installed on the line connecting the opposite ends of the second coil part 7.

Further, to the second coil part 7 is connected a resonance capacitor 10 installed in parallel to the rectifying diode 11. The resonance capacitor 10 is installed on the line connecting opposite ends of the second coil part 7, and also installed between the high voltage transformer 5 and the smoothing capacitor 12. The resonance capacitor 10 forms a resonance circuit, together with the second coil part 7, and charges the high voltage from the high voltage transformer 5. Preferably, the capacity of the resonance capacitor 10 is determined according to the capacity of the smoothing capacitor 12, and is preferably designed to minimize an electric current inputted to the resonance capacitor 10. In order to minimize the electric current inputted to the resonance capacitor 10, it is preferable that the ratio of the capacity of the smoothing capacitor 12 to the capacity of the resonance capacitor 10 is about 5:1 to 10:1.

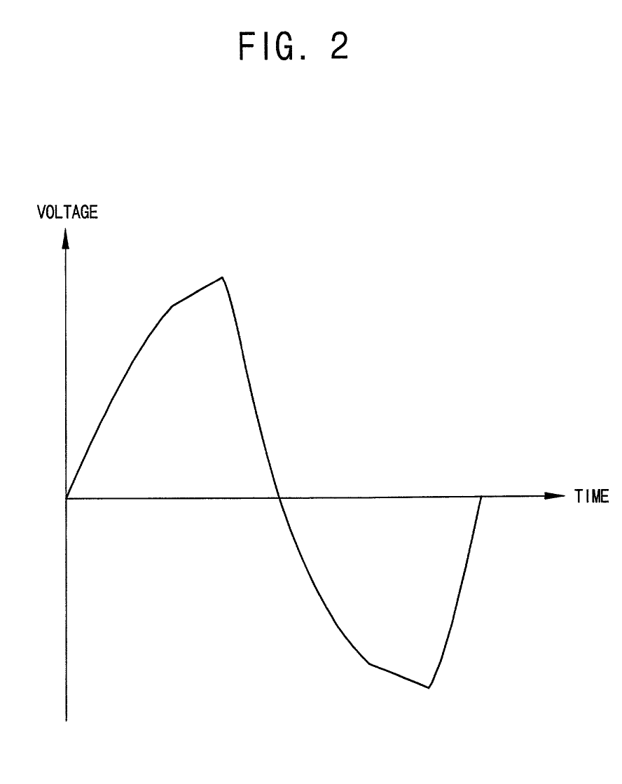

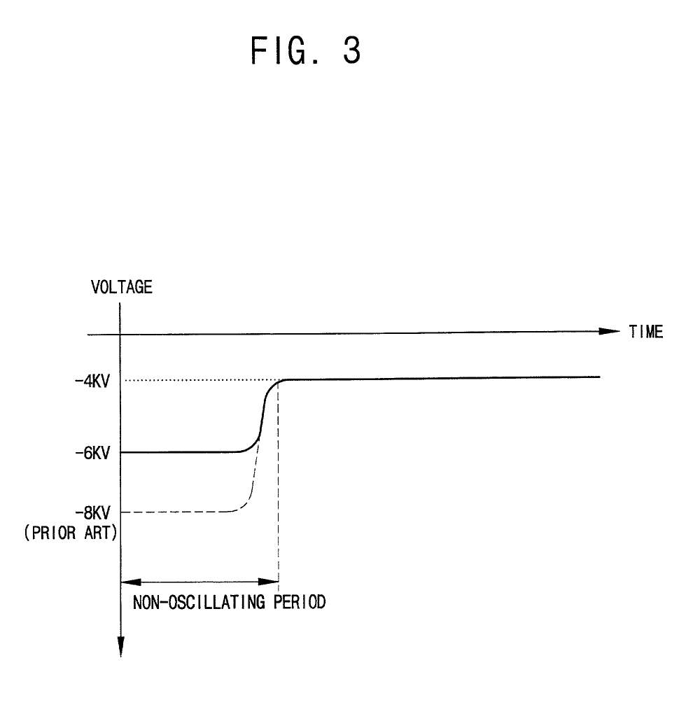

The resonance circuit formed by the resonance capacitor 10 installed to the second coil part 7 can delay supplying the high voltage to the cathode and the anode of the magnetron 1 through the second coil part 7, during the time of charging the resonance capacitor 10 with the high voltage. Accordingly, as depicted in FIG. 3, during the early non-oscillating period, the non-oscillating anode peak voltage supplied to the anode and the cathode of the magnetron 1 is lowered from about 8,000 V to about 6,000 V, and the voltage inversely supplied to the rectifying diode 11 is also lowered to about 6,000 V. Here, the anode peak voltage has a negative value because FIG. 3 shows the waveform of the voltage supplied to the cathode. Further, as shown in FIG. 2, a surge voltage supplied to the filament is also removed. Consequently, it is possible to prevent the filament from being damaged and to lower noises generated in the filament.

With this configuration, at the beginning of operating the microwave oven, if the power supply part 3 supplies electric power to the high voltage transformer 5, voltage of several volts and several thousands volts are respectively induced in the first and second coil parts 6 and 7 of the secondary coil of the high voltage transformer 5. Subsequently, the voltage induced in the second coil part 7 is charged into the resonance capacitor 10 and is rectified through the smoothing capacitor 12 and the rectifying diode 11. Then, the rectified voltage is supplied to the cathode and the anode of the magnetron 1. Simultaneously, the voltage induced in the first coil part 6 of the high voltage transformer 5 is supplied to the filament with the surge voltage being removed. During the non-oscillating period when the filament is heated, the high voltage supplied to the cathode and the anode through the second coil part 7 is lowered by the resonance capacitor 10. That is, the non-oscillating anode peak voltage supplied to the cathode and the anode during the early non-oscillating period is lowered to about 6,000 V. Thereafter, when the filament is heated enough, the anode peak voltage supplied to the cathode and the anode is lowered to about 4,000 V. Then, the cathode emits electron, to thereby generate electromagnetic waves.

Thus, the microwave oven according to the present invention has the resonance capacitor 10 installed at the secondary coil of the high voltage transformer 5 so as to prevent a malfunction in advance by lowering the voltage supplied to the magnetron 1. That is, the resonance capacitor 10 lowers the non-oscillating anode peak voltage during the early non-oscillating period of the magnetron 1, to thereby maintain the performance of the magnetron 1 and prolong the durability thereof. Further, because the high voltage inversely supplied to the rectifying diode 1 is lowered, the rectifying diode 11 is not only protected from damage, but also circuit elements including the rectifying diode 11 connected to the secondary coil of the high voltage transformer 5 can be used in a low voltage. In addition, at the beginning of supplying electric power, the surge voltage passing through the high voltage transformer 5 is removed, and then the waveform of the voltage supplied to the filament is stabilized, and therefore the noise generated from the filament is decreased.

As described above, according to the present invention, the performance of the magnetron is maintained by lowering the anode peak voltage applied thereto during the early non-oscillating period, and the circuit elements are protected from damage by removing the surge voltage.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A microwave oven comprising a magnetron having an anode, a cathode and a filament, and a high voltage transformer having a primary coil and a secondary coil for supplying a high voltage to the magnetron, further comprising:
a capacitor connected in parallel to the secondary coil of the high voltage transformer, forming a resonance circuit with the secondary coil.

2. The microwave oven according to claim 1, wherein the secondary coil is comprised of a first coil part connected to the filament of the magnetron and the second coil part connected to the cathode and the anode of the magnetron; and
the capacitor is connected in parallel to the second coil part.

3. The microwave oven according to claim 1, wherein to the secondary coil of the high voltage transformer is provided a rectifying circuit including a smoothing capacitor and a rectifying diode, and the smoothing capacitor is installed between the high voltage transformer and the rectifying circuit.

4. A method for controlling voltage in a microwave oven comprising a magnetron and a high voltage transformer; including the steps of:
converting voltage supplied from the outside into a high voltage through the high voltage transformer;
resonating the high voltage; and
supplying the high voltage to the magnetron.
